(19) United States
(12) Patent Application Publication
(10) Pub. No.: US 2026/0195991 A1
(43) Pub. Date: Jul. 9, 2026

(54) METHOD FOR GENERATING CUSTOM COMPRESSION GARMENT WITH CHAINMESH

(71) Applicant: Opensuit Corporation, Brooklyn, NY (US)

(72) Inventors: Owen Hoyt, Brooklyn, NY (US); Christopher Knauth, Brooklyn, NY (US); Kikimora Morozova, Boston, MA (US); Indigo Mulligan, Brooklyn, NY (US)

(21) Appl. No.: 19/555,099

(22) Filed: Mar. 3, 2026

Related U.S. Application Data
(63) Continuation-in-part of application No. 19/083,232, filed on Mar. 18, 2025.
(60) Provisional application No. 63/567,022, filed on Mar. 19, 2024.
(60) Provisional application No. 63/766,332, filed on Mar. 3, 2025.

(51) Int. Cl. G06T 17/20; B29C 64/393; B33Y 50/02; B33Y 80/00; G06T 3/40

(52) U.S. Cl. CPC G06T 17/20; B29C 64/393; B33Y 50/02; B33Y 80/00; G06T 3/40

(57) ABSTRACT

One variation of a method includes: accessing a virtual mesh representing a body part; calculating a center line of the virtual mesh; radially downscaling the virtual mesh, radially about the center line, according to a target radial compression for a compression garment; projecting a primary rotation axis of a joint, represented in the virtual mesh, onto the virtual mesh; and calculating a neutral plane corresponding to minimal axial displacement of soft tissue proximal a joint during articulation of the joint. This variation of the method also includes generating a three-dimensional model of the compression garment including: virtual compression links that cooperate to achieve the target radial compression proximal the joint and exhibit a first longitudinal compliance based on proximity to the primary rotation axis and the neutral plane; and virtual connector links that link pairs of adjacent virtual compression links.

### CROSS-REFERENCE TO RELATED APPLICATIONS

This Application claims the benefit of U.S. Provisional Application No. 63/766,332, filed on 3 Mar. 2025, which is incorporated in its entirety by this reference.

This Application is also a continuation-in-part of U.S. patent application Ser. No. 19/083,232, filed on 18 Mar. 2025, which claims the benefit of U.S. Provisional Application No. 63/567,022, filed on 19 Mar. 2024, each of which is incorporated in its entirety by this reference.

### TECHNICAL FIELD

This invention relates generally to the field of compression garments and, more specifically, to a new and useful method for generating custom compression garments with chainmesh.

### BRIEF DESCRIPTION OF THE FIGURES

FIG. 1 is a flowchart representation of a method;

FIG. 2 is a flowchart representation of one variation of the method;

FIG. 3 is a flowchart representation of one variation of the method;

FIG. 4 is a flowchart representation of one variation of the method;

FIG. 5 is a schematic representation of a system;

FIG. 6 is a flowchart representation of one variation of the method; and

FIG. 7 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

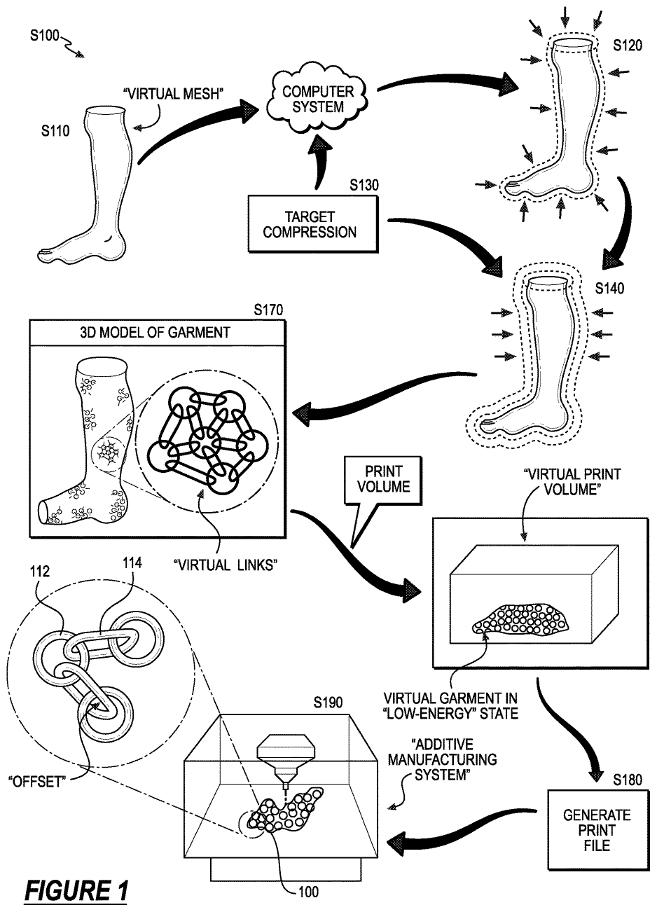

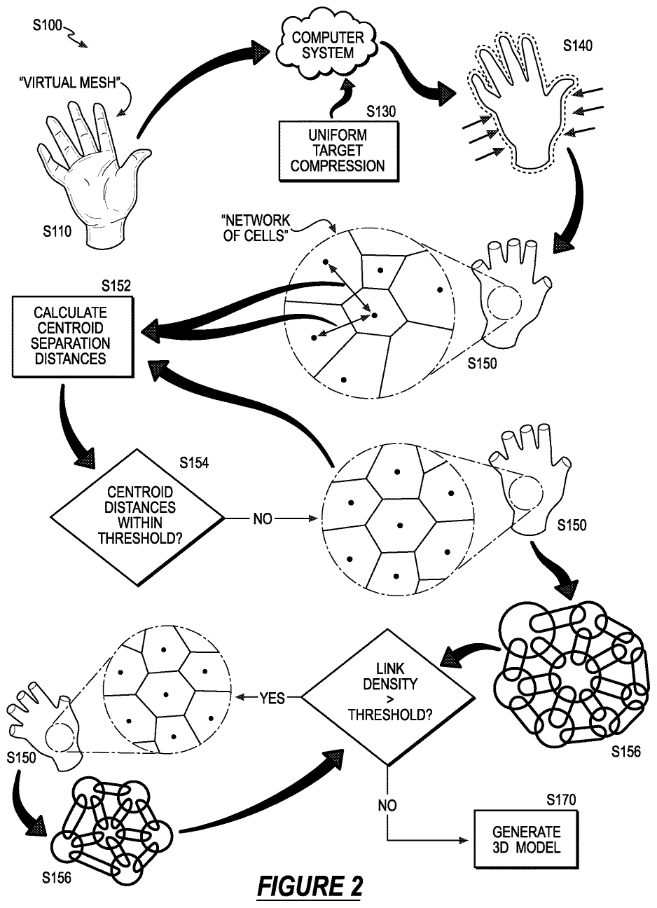

As shown in FIGS. 1 and 2, a method S100 includes: accessing a virtual mesh representing a target body part in Block S110; downscaling the virtual mesh, in three dimensions, according to a manufacturing offset between primary links and secondary links of a compression garment 100, corresponding to the virtual mesh, during additive manufacturing of the compression garment 100 in Block S120; calculating a center line of the virtual mesh in Block S124; accessing a target compression for the compression garment 100 in Block S130; and radially downscaling the virtual mesh, radially about the center line, according to the target compression in Block S140.

The method S100 further includes: constructing a network of tessellated cells intersecting a surface of the virtual mesh in Block S150; characterizing a set of distances between centroids of adjacent tessellated cells in the network of tessellated cells in Block S152; calculating a first proportion of the set of distances that exceed a threshold distance in Block S154; and, in response to the first proportion of the set of distances exceeding a threshold proportion, reconstructing the network of tessellated cells in Block S156.

The method S100 further includes generating a three-dimensional model of the compression garment 100 in Block S170, the three-dimensional model including: a first constellation of virtual primary links, each virtual primary link in the first constellation of virtual primary links defining a toroidal geometry, and located within a tessellated cell in the network of tessellated cells; and a second constellation of virtual secondary links, each virtual secondary link in the second constellation of virtual secondary links linking a pair of adjacent virtual primary links in the first constellation of virtual primary links, and defining a surface offset from surfaces of the pair of adjacent virtual primary links by the manufacturing offset.

### 1.1 Variation: Compression Garment Construction

As shown in FIGS. 1, 4, and 5, one variation of the method S100 includes: accessing a virtual mesh representing a target body part in Block S110; downscaling the virtual mesh, in three dimensions, according to a manufacturing offset between primary and secondary links of a compression garment, corresponding to the virtual mesh, during additive manufacturing of the compression garment 100 corresponding to the virtual mesh in Block S120; downscaling the virtual mesh, in two dimensions, based on a target compression for the compression garment 100 in Block S140; and constructing a network of tessellated cells intersecting a surface of the virtual mesh in Block S150.

This variation of the method S100 further includes generating a three-dimensional model of the compression garment 100 in Block S170, the three-dimensional model including: a first constellation of virtual primary links, each virtual primary link in the first constellation of virtual primary links defining a toroidal geometry, characterized by a primary equatorial plane intersecting and parallel to a surface of a tessellated cell in the first network of tessellated cells, and located within a tessellated cell in the network of tessellated cells; and a second constellation of virtual secondary links, each virtual secondary link in the second constellation of virtual secondary links linking a pair of adjacent virtual primary links in the first constellation of virtual primary links, and defining a surface offset from surfaces of the pair of adjacent virtual primary links by the manufacturing offset.

This variation of the method S100 also includes generating a print file representing the three-dimensional model of the compression garment 100, the print file executable by an additive manufacturing system to construct the compression garment 100, in Block S180.

### 1.2 Variation: Chainmesh Garment

As shown in FIGS. 1, 3, and 5, one variation of the method S100 includes: accessing a virtual mesh representing a target body part for generating a chainmesh garment in Block S110; accessing a target compression for the chainmesh garment in Block S130; downscaling the virtual mesh based on the target compression in Block S140; and defining a seam location on the virtual mesh in Block S174.

This variation of the method S100 further includes: generating a three-dimensional model of the chainmesh garment in Block S170, the three-dimensional model including: a first constellation of virtual primary links, each virtual primary link in the first constellation of virtual primary links flush with a surface of the virtual mesh; a second constellation of virtual secondary links, each virtual secondary link in the second constellation of virtual secondary links linking a pair of adjacent virtual primary links in the first constellation of virtual primary links; and a third constellation of virtual tertiary links, each virtual tertiary link in the third constellation of virtual tertiary links linked to primary links, in the first constellation of virtual primary links, proximal the seam location. This variation of the method S100 also includes additively manufacturing the chainmesh garment according to the three-dimensional model in Block S190.

### 1.3 Variation: Variable-Compliance Compression Garment

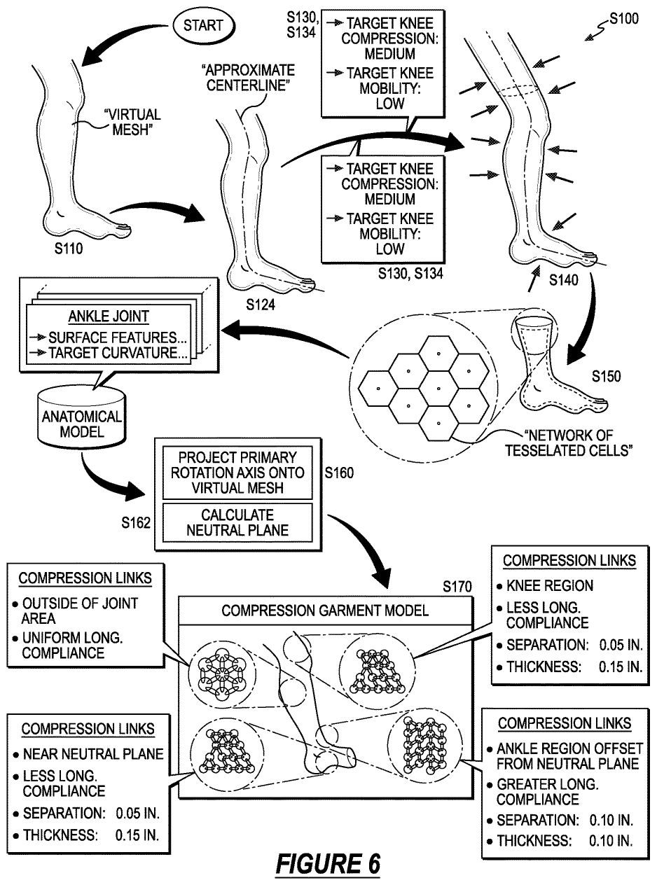

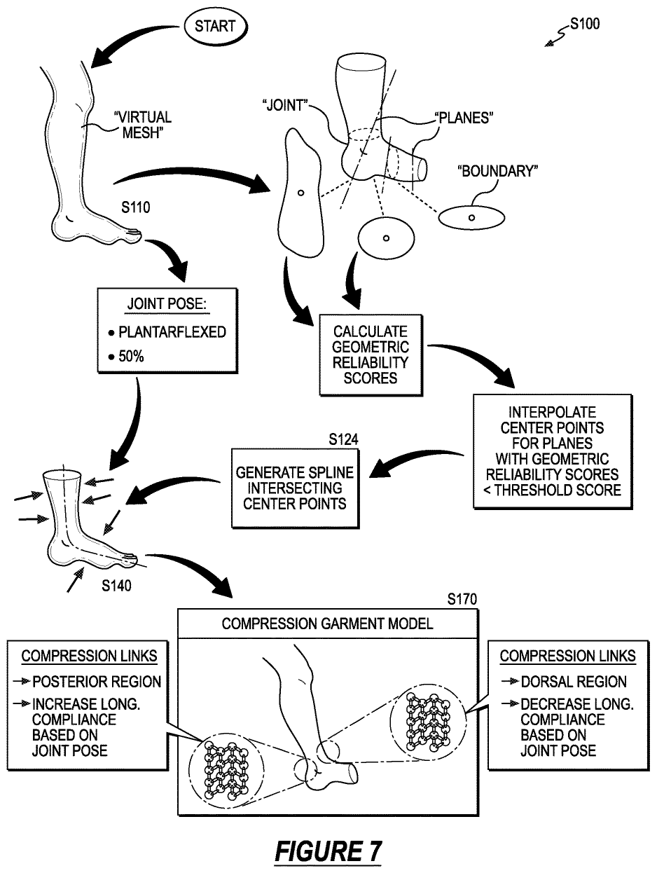

As shown in FIGS. 6 and 7, one variation of the method S100 includes: accessing a virtual representation of a body part in Block S110; calculating a center line of the virtual representation in Block S124; radially downscaling the virtual representation, radially about the center line, according to a target radial compression for a compression garment 100 in Block S140; projecting a primary rotation axis of a joint, represented in the virtual representation, onto the virtual representation in Block S160; and calculating a neutral plane corresponding to minimal axial displacement of tissue of a joint, corresponding to the joint, during articulation of the joint in Block S162.

This variation of the method S100 also includes generating a three-dimensional model of the compression garment 100 in Block S170, the three-dimensional model including: a first set of virtual compression links, each virtual compression link in the first set of virtual compression links cooperating to achieve the target radial compression proximal the joint and exhibiting a first longitudinal compliance, along the center line, based on proximity to the primary rotation axis and the neutral plane; and a second set of virtual connector links, each virtual connector link in the second set of virtual connector links linking a pair of adjacent virtual compression links in the first set of virtual compression links.

### 1.4 Variation: Compression Garment Manufacturing

As shown in FIGS. 6 and 7, one variation of the method S100 includes: accessing a virtual representation of a body part in Block S110; calculating a center line of the virtual representation in Block S124; radially downscaling the virtual representation, radially about the center line, according to a target radial compression for a compression garment 100 in Block S140; and identifying a joint represented in the virtual representation.

This variation of the method S100 also includes generating a three-dimensional model of the compression garment 100 in Block S170, the three-dimensional model including: a first set of virtual compression links, each virtual compression link in the first set of virtual compression links cooperating to achieve the target radial compression and exhibiting a longitudinal compliance based on proximity to the joint; and a second set of virtual connector links, each virtual connector link in the second set of virtual connector links linking a pair of adjacent virtual compression links in the first set of virtual compression links.

This variation of the method S100 further includes additively manufacturing the chainmesh garment according to the three-dimensional model in Block S190.

### 2. Applications

Generally, the method S100 can be executed by a computer system (e.g., a remote computer system, a computer network, a remote server) in conjunction with an additive manufacturing system to transform a three-dimensional scan of a body part (e.g., a leg, a wrist, a torso) into a print file executable by an additive manufacturing system to print a custom “chainmail” garment (e.g., formed from polymer or metal): configured for donning on the body part; and configured to apply a controlled (e.g., uniform, planned non-uniform) compression to the body part when donned on the body part. For example, the method S100 can be executed by the computer system to transform a three-dimensional scan of a patient's foot and leg into a custom compression sock configured to apply a first target tension to the patient's calf, a second target tension to the patient's foot, and less tension to the patient's toes and ankle in order to yield reduced fatigue and greater mobility when the custom compression sock is worn by the patient. In another example, the method S100 can be executed by the computer system to transform a three-dimensional scan of an astronaut's body into a custom compression suit configured to apply different target tension across the astronaut's arms, legs, torso, and joints.

More specifically, the computer system can execute Blocks of the method S100: to access a virtual mesh (e.g., a virtual three-dimensional representation) representing a target body part for generating a compression garment 100; to downscale (e.g., shrink) the virtual mesh according to a post-printing expansion factor; to downscale the virtual mesh according to a target compression for the compression garment 100; to construct a constellation of tessellated cells on a surface of the virtual mesh, including a centroidal Voronoi tessellation, that define a pattern for arranging virtual links on the virtual mesh; to generate a three-dimensional model representing the compression garment 100 and including a network of virtual links arranged on the virtual mesh according to the pattern; and to print the compression garment 100—represented in the three-dimensional model—including a network of real links corresponding to the network of virtual links.

In particular, the compression garment 100 (or a “chainmesh” garment) may be worn by a user in various applications, such as: medical applications (e.g., increasing blood flow, reducing swelling, or post-surgical recovery); athletic support (e.g., muscle stabilization, fatigue reduction, or performance enhancement); and/or aerospace applications (e.g., maintaining blood circulation in high-gravity loading environments, providing structural support in pressurized suits, or providing mechanical counterpressure in non-pressurized suits in low ambient pressure environments). The compression garment 100 includes a network of real, interconnected links formed in a custom cellular structure conforming to the features (e.g., contours) of the target body part. The network of real links can be: rigid when tensioned over the target body part to apply targeted compression; and flexible during donning and doffing to enable the user to easily arrange the compression garment 100 over the target body part.

### 2.1 Compression Control

Generally, the compression garment 100 can be downscaled (or “undersized”) relative to the target body part such that, during wear, the compression garment 100 tensions over and exerts a targeted compression force on the target body part. More specifically, the compression garment 100 can be undersized according to a target compression specified for the compression garment 100. Additionally, a particular region (e.g., a calf region) of the compression garment 100 (e.g., a compression sock) can be undersized according to a regional target compression. For example, the target compression can be based on: a target flexibility or mobility (e.g., increased mobility in joint regions); a target rigidity (e.g., structural reinforcement in load-bearing areas); an intended garment application (e.g., post-surgical recovery) associated with the compression garment 100; and/or a compression garment 100 type (e.g., a compression sock) of the compression garment 100.

In one application, the compression garment 100 can be customized for the particular user by tailoring the network of links to conform to the anatomical features of the target body part. In particular, in this application, the computer system can: access a virtual mesh representing the target body part; downsize the virtual mesh according to the target compression for the compression garment 100; detect features (e.g., contours) of the target body part represented in the virtual mesh; and virtually construct a network of virtual links, arranged on the downsized virtual mesh, that align with the curvature and geometric variations of the target body part to achieve uniform contact and controlled compression distribution. Accordingly, the network of virtual links can define a pattern for constructing a network of real links forming the compression garment 100.

### 2.2 Printing and Garment Generation

An additive manufacturing system can then construct (i.e., print) the compression garment 100 by constructing the network of real links represented by the network of virtual links. Therefore, the computer system can integrate anatomical contours into the construction of the compression garment 100 to enhance fit, maintain consistent compression levels across varying surface geometries, and achieve structural integrity across the network of real links 110 while accommodating user-specific mobility and pressure distribution needs.

In one application, the computer system can identify a configuration of the three-dimensional model within a virtual print volume corresponding to the additive manufacturing system that: minimizes printing time by printing the compression garment 100 to reduce unnecessary print head travel and layer transitions; reduces material waste by efficiently arranging the three-dimensional model within the virtual print volume; and preserves the structural integrity of the compression garment 100 by maintaining spacing between links, preventing unintended fusion, and ensuring post-printing flexibility. In this application, the computer system can: virtually locate (e.g., collapse) a three-dimensional model of the compression garment 100 within the virtual print volume in a low-energy state; and transmit a print file to the additive manufacturing system (e.g., a selective laser sintering (SLS) system) for printing the compression garment 100 according to the low-energy state.

Accordingly, the compression garment 100: can be fabricated via the additive manufacturing system, such that the compression garment 100 is “ready-to-wear” upon execution of the print file (i.e., without requiring additional post-processing); and can be rapidly printed on demand to accommodate individual user specifications. Therefore, the system enables cost-effective, sustainable manufacturing of custom compression garments 100 that reduces material consumption and production time.

### 2.3 Region-Specific Compression and Mobility Characteristics

In one application, the compression garment 100 can be configured to apply a target radial compression profile to a target body part while exhibiting different longitudinal compliance characteristics across regions of the compression garment 100, such that the compression garment 100 accommodates joint motion in selected regions without reducing compression or stability applied to adjacent regions. In particular, conventional compression garments typically rely on uniform elastic materials, in which increased compression increases stiffness and reduces flexibility. Accordingly, these garments may over-constrain joint regions during motion, leading to restricted range of motion, localized pressure spikes, material bunching, or a user discomfort during wear.

Conversely, the compression garment 100 can maintain substantially uniform radial compression across both joint and non-joint regions while selectively permitting axial displacement in circumferential regions of the garment that experience elongation during joint articulation. By varying longitudinal compliance independent of radial compression, the garment accommodates joint motion without relaxing compression or introducing excess slack. In particular, the computer system can execute Blocks of the method S100 to: section a virtual mesh representing the target body part into regions corresponding to different functional requirements; access a target radial compression and a target mobility for each region; and generate a three-dimensional model of the compression garment 100 that includes region-specific networks of virtual links that achieve the target radial compression and the target mobility for each region.

In particular, the computer system can configure circumferential regions of the compression garment 100 encompassing a joint to exhibit different longitudinal compliance based on expected axial deformation of tissue during motion. More specifically, regions of the compression garment 100 corresponding to tissue elongation during articulation can be configured to accommodate axial displacement, while regions corresponding to minimal tissue deformation can be configured to resist axial displacement, thereby permitting joint motion without inducing localized over-constraint or migration of the compression garment 100. For example, a compression garment 100 for a lower limb can be configured such that a knee region exhibits increased longitudinal compliance to permit articulation during walking, while an ankle region exhibits reduced longitudinal compliance to stabilize the joint, without reducing compression applied to either region.

In one application, the computer system can select geometric and material characteristics of virtual links within each region based on the target compression and/or mobility specified for the region. For example, virtual compression links in regions associated with increased mobility can be arranged with greater separation distances, reduced thickness, and/or materials exhibiting greater elasticity to permit relative axial translation (or elastic deformation) during motion. Accordingly, by generating corresponding link networks with region-specific separation, thickness, and material properties, the system can produce compression garments 100 that combine stabilization and mobility within a single garment while maintaining consistent compression during use.

Accordingly, the compression garment 100 preserves therapeutic compression across a range of joint positions while reducing localized over-constraint, minimizing garment migration, and maintaining consistent fit during dynamic motion. Therefore, the compression garment 100 can support applications requiring both sustained compression and repeated articulation, including extended wear, athletic activity, rehabilitation, and pressurized or counterpressure environments.

### 2.4 Centerline-Referenced Anatomical Metrics

In one application, the computer system can calculate quantitative anatomical metrics for the target body part based on the derived center line and associated cross-sectional planes. In particular, the computer system can calculate circumferential dimensions of the target body part at precise distances along the center line and relative to anatomically meaningful reference locations based on cross-sections of the virtual mesh, which are defined at discrete axial locations along the center line,

For example, for each plane projected normal to the center line, the computer system can detect a boundary of the virtual mesh intersecting the plane and calculate a circumference, cross-sectional area, and/or related geometric parameter of the boundary. Additionally, the computer system can calculate volumetric measurements between adjacent planes along the center line. In particular, these metrics are spatially registered relative to the anatomy represented in the virtual mesh, as each measurement is indexed to a position along the center line.

Accordingly, the system can calculate repeatable and anatomically consistent measurements across multiple scans of a user. For example, circumferential measurements obtained at a defined axial distance along the center line in a first scan can be compared directly to circumferential measurements obtained at the same axial distance in a subsequent scan. Thus, these centerline-referenced metrics can support applications including monitoring of swelling, post-surgical recovery, muscle development, or other anatomical changes over time, while leveraging the same geometric framework for generating the compression garment.

### 3. Compression Garment

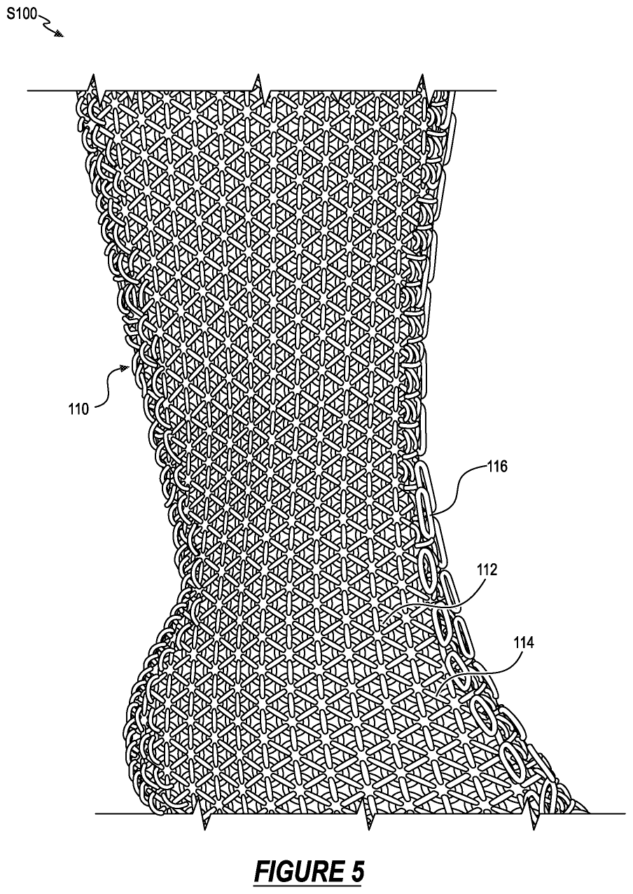

As shown in FIG. 5, a compression garment 100 is configured to: locate over a target body part (e.g., a lower leg, a torso, an elbow joint) of a user; and tension over the target body part to apply a controlled compression force. The compression garment 100 includes: a network of three-dimensional, interconnected links (hereinafter referred to as a “network of links 110”) defining a three-dimensional surface configured to contact (and conform to) a target body surface of the target body part; and a closure mechanism (e.g., a zipper, a dial-based tensioning system, a lace-based system) coupled to the network of links 110 at a seam location and configured to secure the compression garment 100 to the target body part.

The network of links 110 can form a custom cellular structure conformal to the target body part. In particular, when the compression garment 100 is donned over the target body surface, the network of links 110 conforms to the target body part and exerts controlled (or predictable, planned, designed, target) compression (e.g., hoop stress, hoop force) across the target body part. In particular, the network of links 110 can include: a constellation of primary links 112 (e.g., configured to lie flush with the target body surface); a constellation of secondary links 114 (e.g., configured to lie normal to the target body surface) coupling adjacent primary links 112; and a constellation of tertiary links 116 arranged proximal the seam location and configured to couple the closure mechanism to the network of links 110.

Furthermore, in specific regions of the compression garment 100, the geometry of secondary links 114 can be selected to achieve targeted mechanical properties. For example, the major radius of a secondary link 114 (e.g., its height relative to the primary links 112) can be selected to increase mechanical extensibility, such that the network of links 110 can accommodate localized expansion while maintaining overall compression integrity. Conversely, the minor radius (e.g., thickness) of a secondary link 114 can be selected to enhance structural rigidity in regions requiring additional reinforcement, such as load-bearing areas or regions prone to high mechanical stress. By selectively adjusting secondary link geometries, the computer system can tailor the mechanical response of the compression garment 100, such that compression and flexibility are distributed according to the functional needs of different regions of the target body part.

Each link in the network of links 110 can exhibit a link geometry (e.g., a toroidal geometry) and link dimensions (e.g., a link diameter) configured to enable localized control over compression distribution and garment flexibility. In particular, the link geometry and dimensions can be selected to achieve a target compression intensity and/or a target flexibility while maintaining structural integrity under tension.

Furthermore, the compression garment 100 exhibits a total garment surface area less than a body surface area of the target body surface. In particular, the total garment surface can be downscaled (i.e., relative to the target body surface) according to the target compression for the compression garment 100. By downscaling (or “undersizing”) the compression garment 100, the compression garment 100 can tension over the target body part to exert a controlled compression force while conforming to anatomical contours of the target body part.

### 4. Virtual Mesh

Block S110 of the method S100 recites accessing a virtual mesh (or a “virtual representation”) representing a target body part. Generally, in Block S110, the computer system can access a virtual mesh representing a target body part for constructing a compression garment 100.

In one variation, the computer system can: access a set of images of a region of a body captured by a user (e.g., at a mobile device); compile the set of images into a virtual mesh; and crop the virtual mesh to constrain the virtual mesh to surfaces corresponding to the target body part. The computer system can then access a target compression for the compression garment 100.

### 5. Uniform Undersizing for Slack and Manufacturing Offset

Block S120 of the method S100 recites downscaling the virtual mesh, in three dimensions, according to a manufacturing offset (e.g., between 0.05 mm and 0.50 mm) between primary and secondary links of a compression garment, corresponding to the virtual mesh, during additive manufacturing of the compression garment 100 corresponding to the virtual mesh. Generally, in Block S120, the compression garment 100 can be downscaled (or “undersized”) to account for post-processing expansion of the network of links 110 (e.g., slack). In particular, the computer system can downscale the virtual mesh according to (e.g., proportional to) the manufacturing offset, wherein the manufacturing offset accounts for the minimum spacing required between primary and secondary links to prevent fusion during printing of the compression garment 100. Thus, the computer system can downscale the virtual mesh according to the manufacturing offset: to maintain proportions compatible with the target body part; to maintain the manufacturing offset across the network of links 110 to prevent unintended fusing of links during printing of the compression garment 100; and to generate a compression garment 100 that conforms to the target body part and exerts the target compression after post-printing expansion (i.e., during wear).

### 6. Target Compression

Block S130 of the method S100 recites accessing a target compression for the compression garment 100. Generally, the computer system can: access a target compression for the compression garment 100 in Block S130; and derive a configuration (or pattern) for a network of links 110 (i.e., links forming the compression garment 100) that yields the target compression.

### 6.1 Uniform Target Compression

In one implementation, the computer system can access a uniform, predefined target compression for the compression garment 100, such as based on a compression garment type of the virtual mesh. In particular, the computer system can: detect a compression garment type of the virtual mesh based on features (e.g., contours) of the virtual mesh; and access a predefined target compression for the compression garment 100 based on the compression garment type. For example, the computer system can: access a virtual mesh depicting a lower leg; detect a compression sock type of the virtual mesh based on contours of the lower leg represented in the virtual mesh; and access a predefined target compression of 30 mmHg for the compression sock type.

Additionally or alternatively, the computer system can access and/or receive a garment application type (e.g., an intended garment application), such as a medical application. The computer system can then implement methods and techniques described above to access a predefined target compression for the compression garment 100 based on the garment application type.

### 6.2 User-Specified Uniform Compression

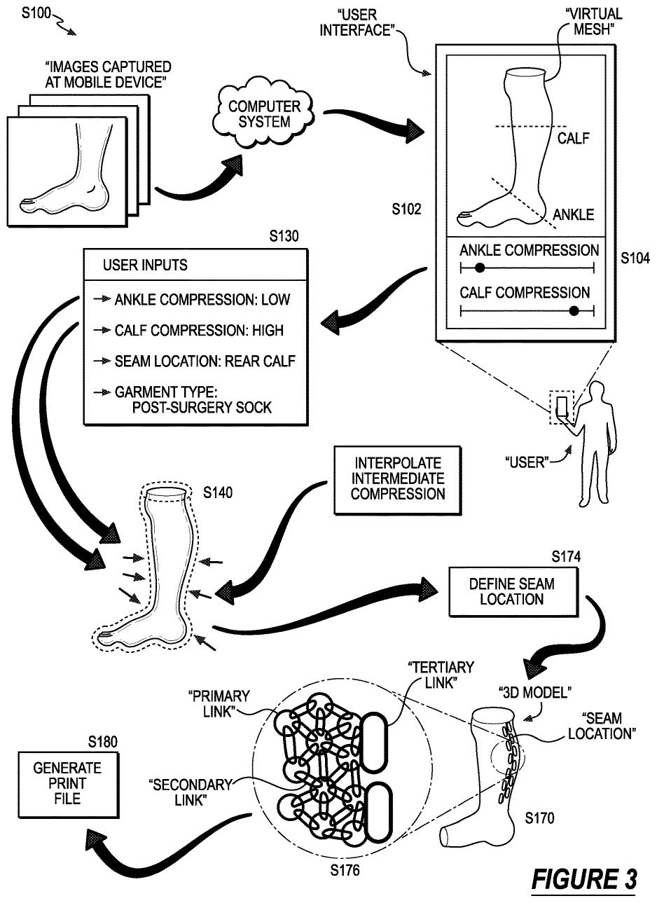

In one variation, as shown in FIG. 3, Blocks of the method S100 recite: rendering the virtual mesh via a user interface in Block S102; generating and transmitting a prompt to indicate the target compression for the virtual mesh via a user interface in Block S104; and receiving selection of the target compression for the virtual mesh from a user in Block S130. In this variation, in Block S130, the computer system can access and/or receive a user-specified target compression for the compression garment 100. In one example, the computer system: renders the virtual mesh via the user interface;
prompts the user to select between predefined target compression profiles (e.g., mild, moderate, firm); and receives selection of a target compression, corresponding to a predefined target compression profile, from the user.

### 6.3 Non-Uniform Compression

In one variation, the computer system can access a predefined target compression for a particular region of the compression garment 100 based on a target mobility for the region. For example, the computer system can: access a virtual mesh depicting an elbow joint; detect a compression sleeve type of the virtual mesh based on contours of the elbow joint represented in the virtual mesh; access a first predefined target compression of 15 mmHg for a forearm region of the compression sleeve type; and access a second predefined target compression of 10 mmHg for an elbow region of the compression sleeve type (e.g., to enable increased mobility at the elbow).

In another variation, the computer system can implement methods and techniques described above to receive a user-specified target compression for a particular region of the compression garment 100. In one example, the computer system: accesses a virtual mesh representing a lower leg; renders a set of predefined compression zones (e.g., calf region, ankle region) on the virtual mesh, each predefined compression zone in the set of predefined compression zones adjacent a slider bar; and, at each predefined compression zone in the set of predefined compression zones, prompts the user to adjust a slider bar to a target compression for the predefined compression zone. The computer system then: receives selection of one or more target compression values for the compression garment 100; constructs a colored gradient, representing a compression gradient of the compression garment 100 (e.g., with regions of higher compression visualized in red) based on the one or more target compression values, intersecting the surface of the virtual mesh; and renders the virtual mesh including the colored gradient (e.g., via the user interface).

In another variation, the computer system can implement methods and techniques described above to: receive a user-specified target compression for a first region of the compression garment 100; and access a predefined target compression, different from the user-specified target compression, for a second target region, excluding the first target region, of the virtual mesh based on target characteristics for the second region. For example, the computer system can: receive selection of a first target compression of 25 mmHg for a forearm region of a compression sleeve; and access a second target compression of 15 mmHg for an elbow region of the compression sleeve, the second target compression based on a predefined target mobility for the elbow region.

Accordingly, the computer system can access custom compression targets for the compression garment 100 (or specific regions of the compression garment 100) to refine compression intensity based on: the compression garment type, such as a compression sock, sleeve, or full-body suit; the intended garment application, such as medical-grade compression for circulation improvement or athletic recovery support; and/or the target mobility requirements, such as reducing compression at joint regions to permit movement while maintaining compression in adjacent areas.

### 7. Center Line Derivation

Block S124 of the method S100 recites calculating a center line of the virtual mesh. Generally, the computer system can: calculate a center line of the virtual mesh in Block S124; and shrink the virtual mesh, in two dimensions, inward toward the center line to downsize the compression garment.

In one implementation, to calculate the center line of the virtual mesh the computer system can: identify normalized line segments representing directions of consistently oriented sections of the mesh (e.g., a foot and calf segment in a leg mesh), define a slicing axis based on the sum of these normalized line segments; and project a first set of planes onto the virtual mesh normal to the slicing axis. The computer system can then, for each plane in the first set of planes: detect a boundary of the virtual mesh intersecting the plane; calculate a centroid of the boundary; and project a center point, in a set of center points, into the virtual mesh at the centroid of the boundary. Based on the normalized line segments formed by sequentially connecting these center points as orthogonals, the computer system can project a second set of planes, recompute the intersections of the mesh and these planes, recompute the centroids, and hence achieve a refined center line. The computer system can then generate the center line including a smooth spline intersecting the set of center points projected into the virtual mesh.

### 8. Uniform Undersizing for Compression

Blocks of the method S100 recite: calculating a center line of the virtual mesh in Block S124; accessing a target compression for the compression garment 100 in Block S130; and radially downscaling the virtual mesh, radially about the center line, according to the target compression in Block S140. Generally, in Block S140, the computer system can downscale the virtual mesh, in two dimensions, based on a target compression (e.g., a uniform target compression) for the compression garment 100. In particular, the computer system can downscale the virtual mesh according to (e.g., proportional to) the target compression to reduce the surface area of the virtual mesh relative to the surface area of the target body surface.

More specifically, the computer system can project a second set of planes onto the virtual mesh and normal to the center line. For each plane in the second set of planes, the computer system can: detect a boundary of the virtual mesh intersecting the plane; and radially downscale the boundary of the virtual mesh (i.e., in two dimensions), within the plane, toward an intersection of the center line within the plane according to the target compression. More specifically, the computer system can shrink the boundary (i.e., the circumference) of each plane, in two dimensions, inward toward the center line of the virtual mesh. Thus, the computer system can downscale the virtual mesh according to the target compression, such that when the compression garment 100 is tensioned over the target body part, the compression garment 100 conforms to the target body part and exerts the target compression.

### 9. Non-Uniform Undersizing for Compression

In one variation, the computer system can downscale discrete regions of the virtual mesh, in two dimensions, according to different compression targets. In particular, in this variation, the computer system can: access a first target compression for a first target region of the virtual mesh corresponding to a first region of the target body part; access a second target compression, different from the first target compression, for a second target region, different from the first target region, of the virtual mesh corresponding to a second region of the target body part; radially downscale the first target region of the virtual mesh, radially about the center line, proportional to the first target compression; and radially downscale the second target region of the virtual mesh, radially about the center line, proportional to the second target compression.

The computer system can then interpolate a smooth surface between the first target region and the second target region to prevent abrupt changes in compression intensity across the virtual mesh. In particular, the computer system can: define an intermediate transition region between the first target region and the second target region; interpolate a scaling factor between the first target compression and the second target compression; and radially downscale the intermediate region, radially about the center line, according to the scaling factor to smooth a transition between the first target region and the second target region.

In one example, the computer system: accesses a virtual mesh representing a lower leg; accesses a first target compression for a calf region of the virtual mesh based on a first target mobility for the calf region; and accesses a second target compression, less than the first target compression, for an ankle region of the virtual mesh based on a second target mobility, greater than the first target mobility, for the ankle region. The computer system then implements methods and techniques described above to: radially downscale the calf region of the virtual mesh proportional to the first target compression; radially downscale the ankle region of the virtual mesh proportional to the second target compression; and radially downscale an intermediate region of the virtual mesh, between the calf region and the ankle region, according to the scaling factor interpolated between the first target compression and the second target compression. Accordingly, the computer system can: downscale discrete regions of the virtual mesh based on different compression targets for these discrete regions; and smooth transitions between these discrete regions to prevent abrupt changes in compression intensity that may cause the user discomfort and/or induce stress concentrations, irregular deformation, or mechanical instability within the network of links 110.

### 10. Virtual Link Pattern

Block S150 of the method S100 recites constructing a network of tessellated cells intersecting a surface of the virtual mesh. Generally, in Block S150, the computer system can: construct a network of tessellated cells (e.g., approximating a centroidal Voronoi diagram); and project the network of tessellated cells onto a surface of the virtual mesh. In particular, the network of tessellated cells can define a pattern for arranging a network of virtual links on the virtual mesh. More specifically, each tessellated cell in the network of tessellated cells defines a boundary circumscribing the tessellated cell and defining a geometry and dimensions (e.g., an approximate radius) of the tessellated cell.

At each tessellated cell in the network of tessellated cells, a virtual primary link can be arranged over the tessellated cell such that the virtual primary link approximates a boundary of the tessellated cell. Thus, at each tessellated cell in the network of tessellated cells, the geometry and dimensions of the tessellated cell define the geometry and dimensions of the virtual primary link. Furthermore, the pattern defined by the network of tessellated cells can be translated into a real link pattern of a network of real links 110 forming the compression garment 100. Therefore, the computer system can define a network of tessellated cells arranged in a pattern exhibiting target pattern characteristics, such that a network of real links 110 constructed according to the pattern exhibits target mechanical properties (e.g., directional stiffness, or localized flexibility).

### 11. Iterative Tessellated Cell Refinement

Blocks of the method S100 recite: characterizing a set of distances between centroids of adjacent tessellated cells in the network of tessellated cells in Block S152; calculating a proportion of the set of distances that exceeds a threshold distance in Block S154; and, in response to the proportion of the set of distances exceeding a threshold proportion, reconstructing the network of tessellated cells in Block S150 (i.e., in order to reduce the proportion of the set of distances between centroids of adjacent tessellated cells in the network of tessellated cells exceeding a threshold proportion).

Generally, the computer system can iteratively refine the network of tessellated cells to achieve a network of tessellated cells exhibiting target pattern characteristics, such as an approximately uniform cell density, cell size, and cell geometry across the virtual mesh. In particular, the computer system can: characterize a set of distances between centroids of adjacent tessellated cells in the network of tessellated cells; calculate a proportion of the set of distances that exceed a threshold distance; and, in response to the proportion of the set of distances exceeding a threshold proportion, reconstruct the network of tessellated cells.

In one implementation, the computer system can: characterize a set of dimensions of each tessellated cell in the network of tessellated cells; and, in response to a dimension of a tessellated cell in the network of tessellated cells falling outside of a target dimension range, reconstruct the network of tessellated cells. The computer system can then iteratively repeat this process to construct a network of tessellated cells exhibiting target pattern characteristics. By refining the spacing and/or geometry of the network of tessellated cells, the computer system mitigates structural inconsistencies that may compromise garment integrity, induce stress concentrations, or result in unintended pressure variations across the compression garment 100. Thus, the computer system can iteratively refine the network of tessellated cells, such that a network of real links 110, constructed according to the network of tessellated cells, can be manufactured with structurally rigid materials while exhibiting a perceptible softness through finely distributed link geometries.

### 11.1 Iterative Tessellated Cell Refinement Based on Link Density

Blocks of the method S100 recite: for each tessellated cell in the network of tessellated cells, characterizing a secondary link density in Block S156; and, in response to a secondary link density of a tessellated cell in the network of tessellated cells deviating from a target link density range, reconstructing the network of tessellated cells in Block S150. Generally, as shown in FIG. 2, the computer system can iteratively refine the network of tessellated cells, such that a network of virtual links constructed according to the network of tessellated cells exhibits a target link arrangement. In particular, the computer system can iteratively refine the network of tessellated cells to achieve a link density within a target link density range for each tessellated cell. For example, the target link density range can represent: a target quantity of virtual secondary links linked to a particular virtual primary link (e.g., between five to seven virtual secondary links per virtual primary link); and/or a target offset between each secondary link linked to a particular virtual primary link.

In one variation, the computer system can virtually locate a virtual network of links 110 by, for each tessellated cell in the network of tessellated cells: virtually constructing a virtual primary link located within the tessellated cell; and virtually arranging a set of virtual secondary links linked to the virtual primary link. The computer system can then characterize a secondary link density corresponding to each tessellated cell in the network of tessellated cells. In particular, the computer system can characterize a secondary link density of the tessellated cell based on: a quantity of virtual secondary links in the set of virtual secondary links; and/or an offset distance between adjacent virtual secondary links in the set of virtual secondary links.

In another variation, the computer system can characterize a secondary link density of the tessellated cell: proportional to a count of edges of the tessellated cell; and/or inversely proportional to an area of the tessellated cell. In response to a secondary link density of a tessellated cell (or a set of tessellated cells) in the network of tessellated cells deviating from a target link density range, the computer system can reconstruct the network of tessellated cells.

By refining the secondary link density within the network of tessellated cells, the computer system mitigates structural instabilities that may arise from: excessive link clustering, which may generate high-density zones that restrict movement and compromise compression application; and/or insufficient link connectivity, which may cause excessive deformation or mechanical failure of the compression garment 100 when tensioning over the target body part. Thus, the computer system iteratively refines the network of tessellated cells, such that a network of real links 110, constructed according to the network of tessellated cells, exhibits target load distribution and deformation characteristics.

### 12. Three-Dimensional Model of Compression Garment

Block S170 of the method S100 recites generating a three-dimensional model of the compression garment 100. Generally, in Block S170, upon deriving the network of tessellated cells, the computer system can generate a three-dimensional model of the compression garment 100 including a network of virtual links constructed according to the pattern defined by the network of tessellated cells.

In one implementation, the computer system can generate a three-dimensional model of the compression garment 100 including: a constellation of virtual primary links, each virtual primary link in the constellation of virtual primary links located within a tessellated cell in the network of tessellated cells; and a constellation of virtual secondary links, each virtual secondary link in the constellation of virtual secondary links linking a pair of adjacent virtual primary links in the constellation of virtual primary links. In particular, each virtual primary link in the constellation of virtual primary links can define a toroidal geometry. More specifically, each virtual primary link can be characterized by a primary equatorial plane intersecting and parallel to a surface of a tessellated cell in the network of tessellated cells. By aligning the network of virtual primary links with the underlying body contours, the computer system generates the virtual primary links conforming to the curvature of the virtual mesh;

Furthermore, each virtual secondary link in the constellation of virtual secondary links: can intersect surfaces of a pair of adjacent tessellated cells in the network of tessellated cells; and can be characterized by a secondary equatorial plane perpendicular to surfaces of the pair of adjacent tessellated cells in the network of tessellated cells. More specifically, each virtual secondary link can define a surface offset from surfaces of the pair of adjacent virtual primary links by the manufacturing offset. More specifically, each virtual secondary link can maintain the manufacturing offset to prevent unintended fusing of links during printing of the compression garment 100.

### 13. Seam Location

In one variation, Blocks of the method S100 recite: defining a seam location on the virtual mesh, the seam location defining a region for excluding primary links and secondary links in Block S174; and injecting a constellation of virtual tertiary links into the three-dimensional model of the compression garment 100, each virtual tertiary link in the constellation of virtual tertiary links linked to primary links, in the constellation of virtual primary links, proximal the seam location in Block S176. In this variation, in Block S174, the computer system can define and/or receive selection of a seam location (e.g., a location for the closure mechanism) for the virtual mesh. In particular, the seam location can define a region proximal the seam location for excluding primary links and secondary links. Thus, the computer system can generate the three-dimensional model of the compression garment excluding virtual primary links and virtual secondary links from the three-dimensional model adjacent the seam location on the virtual mesh.

In this variation, the computer system can inject a constellation of virtual tertiary links into the three-dimensional model of the compression garment 100, each virtual tertiary link in the constellation of virtual tertiary links linked to primary links, in the constellation of virtual primary links, proximal the seam location (i.e., adjacent and offset from the seam location). More specifically, each virtual tertiary link can be configured to couple to a closure mechanism of the compression garment 100. Thus, the computer system can integrate virtual tertiary links near the seam location to facilitate attachment of the closure mechanism while preserving structural integrity and ensuring consistent load distribution across the network of links 110 during garment tensioning.

In particular, each virtual tertiary link can be configured to couple to a closure mechanism, such as a zipper, a dial-based tensioning system, or a lace-based system. In one example, the compression garment 100 includes a zipper configured to secure the garment over the target body part in a fully-tensioned configuration, wherein the zipper applies uniform radial compression by distributing tension evenly across the network of links 110 upon fastening.

In another example, the compression garment 100 includes a lace-based system configured to dynamically adjust the compression of the compression garment. In particular, a user may incrementally tighten or loosen the compression garment, via the lace-based system, to achieve a desired compression level. Additionally or alternatively, the user may incrementally tighten or loosen the compression garment, via the lace-based system, to achieve a desired compression level at a particular region of the compression garment by increasing a local hoop stress proximal to the region. Thus, the computer system can integrate virtual tertiary links proximal to the seam location to accommodate various closure mechanisms to generate a compression garment configured to exert immediate uniform compression or adjustable compression based on user-applied tension, while maintaining consistent load distribution across the network of links 110.

### 14. Garment Generation

Blocks of the method S100 recite: generating a print file representing the three-dimensional model of the compression garment 100 in Block S180; and printing the compression garment 100 according to the print file at an additive manufacturing system in Block S190. Generally, in Block S180, upon generating the three-dimensional model of the compression garment 100, the computer system can generate a print file for an additive manufacturing system (e.g., a selective laser sintering (SLS) system) to construct (i.e., print) a compression garment 100 according to the three-dimensional model.

Upon generating the print file, an additive manufacturing system can print the print file to construct the compression garment 100. In particular, the additive manufacturing system can print a network of real links 110 corresponding to the network of virtual links (e.g., virtual primary links, virtual secondary links, and/or virtual tertiary links), each real link in the network of real links 110 maintaining the manufacturing offset to prevent fusion between adjacent links in the network of real links 110.

### 14.1 Low-Energy State

In one variation, as shown in FIG. 1, the computer system can generate the print file representing the three-dimensional model (e.g., a mesh analog representation) in a low-energy (e.g., collapsed) state within a predefined, virtual print volume (e.g., a rectilinear virtual print volume) representing a print volume of the additive manufacturing system. In this variation, the computer system can: access a virtual print volume corresponding to a print volume of the additive manufacturing system; virtually locate (e.g., collapse) the three-dimensional model of the compression garment 100 into the virtual print volume in a low-energy state while maintaining the manufacturing offset; and generate a print file representing the three-dimensional model in the low-energy state.

For example, the computer system can: bias the three-dimensional model of the compression garment 100, virtually collapsed into the virtual rectilinear print volume, toward a minimum height within the virtual rectilinear print volume; and generate the print file according to a geometry of the three-dimensional model of the compression garment collapsed and biased toward a minimum height within the virtual rectilinear print volume. In this example, the computer system can access a virtual gravity model or physics-based simulation to bias the three-dimensional model of the compression garment 100, virtually collapsed into the virtual rectilinear print volume, toward a stable minimum-energy configuration. Thus, the computer system virtually locates the three-dimensional model of the compression garment 100 into the virtual print volume, such that the compression garment 100 is printed in a configuration that:
minimizes printing time by printing the compression garment 100 to reduce unnecessary print head travel and layer transitions; and preserves the structural integrity of the compression garment 100 by maintaining spacing between links, preventing unintended fusion, and ensuring post-printing flexibility.

### 15. Multi-Segment Compression Garment

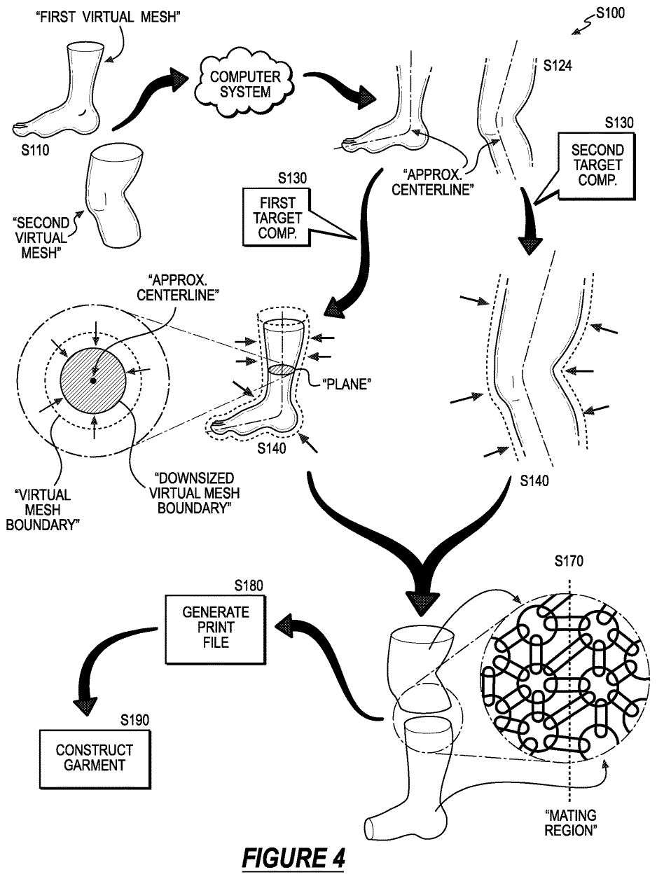

In one variation, as shown in FIG. 4, the system can generate multi-segment compression garments, such as a full-body suit (e.g., including a torso segment, an arm segment, and a leg segment), or a modular compression system (e.g., a sleeve and glove combination for upper limb compression therapy). In this variation, the computer system can implement methods and techniques described above to generate a first three-dimensional model of a first compression garment 100 (e.g., a compression sleeve) for a first target body part (e.g., an arm), the first compression garment 100 downscaled according to a first target compression. The computer system can then implement methods and techniques described above to: access a second virtual mesh representing a second target body part (e.g., a hand), adjacent the first target body part, for constructing a second compression garment 100 (e.g., a compression glove); downscale the second virtual mesh based on a second target compression for the second compression garment 100; and generate a second three-dimensional model of the second compression garment 100.

In particular, the second three-dimensional model can include: a constellation of virtual primary links; a first constellation of virtual secondary links, each virtual secondary link in the first constellation of virtual secondary links linking a pair of adjacent virtual primary links in the constellation of virtual primary links; and a second constellation of virtual secondary links, each virtual secondary link in the second constellation of virtual secondary links arranged along an edge of the second compression garment 100 configured to mate with the first compression garment 100. More specifically, each virtual secondary link in the second constellation of virtual secondary links can link a first virtual primary link in the constellation of virtual primary links of the first three-dimensional model, and a second virtual primary link, adjacent the first virtual primary link, in the constellation of virtual primary links of the second three-dimensional model. The computer system can then: implement methods and techniques described above to generate a print file representing the first three-dimensional model of the first compression garment 100 in a first low-energy state and the second three-dimensional model of the second compression garment 100 in a second low-energy state; and construct a multi-segment compression garment 100 including the first compression garment 100 and the second compression garment 100. Thus, the system can construct a complex, multi-segment compression garment 100 that is custom-fit to a particular user.

In one variation, the system can generate a modular compression garment including a set of discrete compression garments configured to affix to one another following construction of each discrete compression garment. In this variation, the computer system can generate a first three-dimensional model of a first compression garment 100 (e.g., a compression sleeve) for a first target body part (e.g., an arm), the first compression garment 100 downscaled according to a first target compression.

The computer system can then implement methods and techniques described above to: access a second virtual mesh representing a second target body part (e.g., a torso), adjacent the first target body part, for constructing a second compression garment 100 (e.g., a compression vest); downscale the second virtual mesh based on a second target compression for the second compression garment 100; and generate a second three-dimensional model of the second compression garment 100. In particular, in this variation, the second three-dimensional model can include: a constellation of virtual primary links; a constellation of virtual secondary links, each virtual secondary link in the constellation of virtual secondary links linking a pair of adjacent virtual primary links in the constellation of virtual primary links; and a constellation of virtual tertiary links, each virtual tertiary link in the constellation of virtual tertiary links linked to primary links, in the constellation of virtual primary links, proximal a seam location between the first compression garment 100 and the second compression garment 100.

The computer system can then: generate a print file representing the first three-dimensional model of the first compression garment 100 and the second three-dimensional model of the second compression garment 100; construct the first compression garment 100; and construct the second compression garment 100 (i.e., for later assembly with the first compression garment 100).

### 16. Center Line Refinement Across Joint Regions

In one variation, as shown in FIG. 7, the computer system can calculate a center line of the virtual representation (e.g., a virtual mesh) that maintains geometric continuity (e.g., smooth variation in center line position) across joint regions despite local geometric ambiguity and rapid curvature change at joints. In this variation, the computer system can implement methods and techniques described above to: define an axis intersecting vertices arranged at a maximum separation distance in the virtual representation; project a set of planes onto the virtual representation normal to the axis; for each plane in the set of planes, project a center point, in a set of center points, of the plane into the virtual representation; and generate the center line including a spline intersecting the set of center points projected into the virtual representation. In particular, in this variation, the computer system can: map an anatomical model, representing a reference anatomy, to the virtual representation; and identify a joint, represented in the virtual representation, based on correspondence between anatomical features (e.g., surface curvature extrema, local diameter minima, or geometry), represented in the virtual representation, and reference features represented in the anatomical model (e.g., joint locations, bone segment transitions, or labeled landmarks).

Then, for each plane, in the set of planes, intersecting the joint, the computer system can calculate a geometric reliability score for the plane, such as based on a combination of: a magnitude of deviation between a projected center point of the plane and a local trend of adjacent center points along the axis; a magnitude of non-uniformity or discontinuity in intersections between the plane and the virtual representation (i.e., the boundary of the plane); and an angular deviation between a local tangent associated with the plane and tangents associated with adjacent planes.

The computer system can then identify a subset of planes, in the set of planes, characterized by a geometric reliability score falling below a threshold score, such as planes intersecting regions of rapid curvature change at the joint. In particular, at joint regions, planes normal to the axis may fail to represent a local cross-section of a single anatomical segment and instead intersect multiple anatomical regions simultaneously, resulting in projected center points that are not representative of a local joint geometry. More specifically, if incorporated into center line generation, these planes may propagate unnecessary center line deviation and require additional material or increased link density to compensate for geometric distortion at the joint. For example, the computer system can identify a plane (e.g., intersecting an ankle joint of a virtual leg) that simultaneously intersects portions of a foot segment and a lower-leg segment, thus resulting in an unreliable projected center point for center line generation (e.g., biased towards the lower-leg segment).

Furthermore, planes intersecting joint regions may exhibit sharply deviating normal orientations relative to adjacent planes due to rapid curvature change and reduced cross-sectional regularity at the joint. As a result, these planes may generate irregular longitudinal spacing between adjacent cross-sections, including: regions of the virtual representation not intersected by any plane, thereby creating gaps in cross-sectional coverage; and/or regions intersected by multiple adjacent planes, thereby creating overlapping cross-sections. Additionally or alternatively, gaps in cross-sectional coverage may prevent accurate calculation of local circumferential dimensions relative to the center line and may impair radial downscaling of the virtual representation in these regions. Conversely, overlapping cross-sections may generate redundant or conflicting circumferential measurements that distort local undersizing calculations. Accordingly, unreliable planes at joint regions may degrade both center line accuracy and cross-sectional measurement fidelity, thereby propagating error into compression scaling, link distribution, and garment fit proximate the joint.

Accordingly, for each plane in the subset of planes, the computer system can interpolate a center point of the plane based on center points of adjacent planes characterized by geometric reliability scores exceeding the threshold score. In particular, the computer system can interpolate center points across the joint such that the center line transitions smoothly between adjacent non-joint regions while avoiding discontinuities introduced by unreliable planes intersecting the joint.

Furthermore, for each plane, in the set of planes, intersecting a region of the virtual representation outside of the joint, the computer system can: detect a boundary of the virtual representation intersecting the plane; calculate a centroid of the boundary; and project a center point of the plane into the virtual representation at the centroid of the boundary. The computer system can then: generate the center line including a smooth spline intersecting the set of center points projected into the virtual representation; and implement methods and techniques described above to shrink the virtual representation, in two dimensions, inward toward the center line to downsize the compression garment 100.

Accordingly, the computer system can generate a center line that maintains geometric continuity across joint regions, thereby preventing abrupt shifts in center line position or orientation that may propagate into inaccurate or non-uniform downsizing of the virtual representation, or localized distortion of the compression garment 100 (e.g., resulting in poor fit) proximate the joint. Furthermore, rather than recomputing the center line across the entire virtual representation, the computer system limits geometric evaluation and correction to planes intersecting the joint, thereby preserving previously-computed center points in non-joint regions.

### 17. Target Radial Compression+Joint Mobility for Compression Garment

Blocks of the method S100 recite: projecting a primary rotation axis of a joint, represented in a virtual representation, onto the virtual representation in Block S160; and calculating a neutral plane corresponding to minimal axial displacement of soft tissue proximal the joint, parallel to the center line, during articulation of the joint in Block S162.

In one implementation, as shown in FIG. 6, the system can generate a compression garment 100 configured to maintain a target radial compression on the body part while permitting articulation of a joint encompassed by the compression garment 100. In particular, the compression garment 100 can independently control radial compression and joint compliance, such that: the compression garment 100 enables targeted immobilization or enhanced mobility at one or more joints without altering the target radial compression applied to adjacent regions of the body part; and joint compliance is not constrained to a single mode in which increased compression results in increased stiffness and decreased flexibility. For example, the compression garment 100 can be configured for a limb encompassing a joint such that regions proximal and distal to the joint maintain therapeutic compression, while circumferential regions of the garment aligned with articulation-induced elongation are configured with increased longitudinal compliance to permit bending of the joint without loss of compression or garment migration.

In this implementation, the computer system can implement methods and techniques described above to: access a virtual representation of a body part; calculate a center line of the virtual representation; and radially downscale the virtual representation, radially about the center line, according to a target radial compression for a compression garment 100.

The computer system can then identify regions of the virtual representation that undergo axial displacement (and minimal axial displacement) during articulation of the joint based on known kinematics of the joint. In particular, the computer system can:
map an anatomical model, representing a reference anatomy, to the virtual representation; identify a joint, represented in the virtual representation, based on correspondence between anatomical features, represented in the virtual representation, and reference features represented in the anatomical model; and project a primary rotation axis of the joint onto the virtual representation. More specifically, the computer system can map the primary rotation axis, defined in the anatomical model for the particular joint type, to the virtual representation, the primary rotation axis corresponding to an estimated axis of relative rotation between adjacent anatomical segments represented in the virtual representation.

The computer system can then calculate a neutral plane corresponding to minimal axial displacement of soft tissue proximal the joint, parallel to the center line, during articulation of the joint. In particular, the computer system can calculate the neutral plane relative to the primary rotation axis and the center line (e.g., as a circumferential reference) for interpreting axial deformation of the virtual representation during joint articulation. For example, the computer system can calculate the neutral plane intersecting the primary rotation axis and parallel to the center line. More specifically, the computer system can: snap a three-dimensional surface onto the center line; orient the three-dimensional surface parallel to the primary rotation axis of the joint; and define the neutral plane along an outer surface of the virtual representation at an intersection between the three-dimensional surface and the outer surface.

The computer system can then implement methods and techniques described below to generate a three-dimensional model of the compression garment 100 that includes: a set of virtual compression links that cooperate to achieve the target radial compression; and a set of virtual connector links that link pairs of adjacent virtual compression links. Accordingly, the system can generate a compression garment 100 configured to permit mobility (or immobility) of a particular joint without compromising compression performance or fit of the compression garment 100.

### 17.1 Longitudinal Compliance for Joint Articulation

In one implementation, the computer system can select longitudinal compliance for regions of the compression garment 100 based on joint articulation, such that different circumferential regions of the compression garment 100 exhibit different resistance to axial displacement during articulation of a joint. In particular, the computer system can generate a three-dimensional model of the compression garment 100 that includes: virtual compression links (e.g., primary links) that cooperate to achieve the target radial compression and exhibit a longitudinal compliance to permit articulation of the joint; and virtual connector links that link adjacent virtual compression links. More specifically, the virtual compression links can cooperate to achieve the target radial compression on the joint while the joint locates over a range of joint positions.

In particular, the three-dimensional model can include virtual compression links: arranged proximal regions of the joint that exhibit axial displacement of tissue during articulation (e.g., offset from the neutral plane); and configured to displace along the center line, relative to adjacent virtual compression links, to permit articulation of the joint over the range of joint positions. The three-dimensional model can further include virtual compression links: arranged proximal regions of the joint that exhibit minimal axial displacement of soft tissue during articulation (e.g., proximal the neutral plane); and configured to resist axial displacement while other virtual compression links displace along the center line to permit articulation of the joint.

In particular, the three-dimensional model can include virtual compression links that exhibit a longitudinal compliance along the center line: proportional to a first distance from the primary rotation axis; and proportional to a second distance from the neutral plane. More specifically, virtual compression links arranged proximal the primary rotation axis can exhibit relatively greater longitudinal compliance to accommodate axial elongation of tissue occurring during articulation of the joint. Conversely, virtual compression links arranged at a distal end of the garment or farther from the primary rotation axis can exhibit relatively smaller longitudinal compliance, corresponding to reduced axial displacement of tissue during articulation of the joint.

Additionally, during articulation of the joint, the virtual compression links cooperate circumferentially to maintain the target radial compression, such that axial displacement of selected virtual compression links occurs without reducing circumferential compression applied by the compression garment 100. Accordingly, the compression garment 100 maintains target radial compression while virtual compression links offset from the neutral plane displace axially along the center line to accommodate articulation of the joint.

In one example, a three-dimensional model for a compression sock (i.e., a compression garment 100) can include virtual compression links arranged proximal an ankle joint and including: a first subset of virtual compression links arranged proximal a dorsal region of the ankle joint (e.g., exhibiting maximum axial displacement of tissue during articulation); and a second subset of virtual compression links arranged proximal a plantar or medial region of the ankle joint (e.g., exhibiting minimal axial displacement of soft tissue during articulation).

In this example, the first subset of virtual compression links can displace along the center line, relative to adjacent virtual compression links, to permit articulation of the ankle joint. Conversely, the second subset of virtual compression links can resist axial displacement while the first subset of virtual compression links displace along the center line. Thus, in this example, the second subset of virtual compression links stabilizes the compression garment 100 at the ankle joint while permitting displacement of the first subset of virtual compression links, such as to accommodate joint articulation without loss of radial compression or migration of the compression garment 100.

Furthermore, the computer system can selectively apply joint-specific longitudinal compliance only to regions proximal a joint (i.e., associated with articulation). For example, the computer system can generate the three-dimensional model (e.g., for a compression sock) including: a first set of virtual compression links arranged proximal the joint (e.g., an ankle joint); and a second set of virtual compression links arranged proximal a region (e.g., a calf region) of the three-dimensional model excluding the joint. In this example, the first set of virtual compression links: cooperates to achieve the target radial compression proximal the joint; and exhibits a longitudinal compliance, along the center line, based on proximity to the primary rotation axis and the neutral plane. Additionally, the second set of virtual compression links: cooperates to achieve the target radial compression proximal the region of the three-dimensional model excluding the joint; and exhibits a uniform longitudinal compliance. Thus, the computer system can select variable longitudinal compliance in regions of the compression garment 100 experiencing joint articulation while maintaining uniform longitudinal compliance in non-joint regions, where axial displacement during motion is substantially reduced or absent.

### 17.2 Longitudinal Compliance: Link Characteristics

In one variation, the computer system can modulate longitudinal compliance of the compression garment 100 by selecting geometric and material characteristics of virtual compression links, which correspond to physical characteristics of real compression links in a fabricated compression garment 100.

For example, the three-dimensional model (e.g., for a compression sock) can include virtual compression links: spaced apart by varying separation distances based on proximity to the primary rotation axis and the neutral plane; and configured to translate along the center line, relative to adjacent virtual compression links, to permit articulation of the joint. In particular, the computer system can: select a target longitudinal compliance for a particular region of the compression garment 100 based on proximity of the region to the primary rotation axis and the neutral plane; and select a separation distance, proportional to the target longitudinal compliance, for a virtual compression link located within the region.

In one example, the set of virtual compression links can include: a first subset of virtual compression links arranged proximal the joint and spaced apart by a first separation distance, the first separation distance permitting relative translation of the first subset of virtual compression links along the center line during articulation; and a second subset of virtual compression links arranged farther from the joint and spaced apart by a second separation distance smaller than the first separation distance, the second separation distance limiting relative translation of the second subset of virtual compression links along the center line.

In another variation, the three-dimensional model (e.g., for a compression sock) can include virtual compression links: exhibiting a thickness inversely proportional to a target longitudinal compliance of the virtual compression link; and configured to deform along the center line to permit articulation of the joint. In one example, the set of virtual compression links can include: a first subset of virtual compression links arranged proximal the joint and exhibiting reduced thickness to permit increased axial deformation during articulation; and a second subset of virtual compression links arranged farther from the joint and exhibiting increased thickness to resist axial deformation during articulation.

In another variation, the computer system can select a particular material for each virtual compression link based on a target longitudinal compliance of the virtual compression link. For example, the computer system can: select a first material exhibiting greater elasticity for virtual compression links arranged proximal the joint; and select a second material exhibiting lower elasticity for virtual compression links arranged farther from the joint.

### 17.3 Variation: Longitudinal Compliance Based on Joint Pose

In one variation, the computer system can: access a virtual representation depicting a joint pose of the joint; and select target longitudinal compliance for each of the virtual compression links based on the joint pose. In particular, in this variation, the computer system can: calculate the neutral plane based on the joint pose; and select a target longitudinal compliance for each of the virtual compression links based on a circumferential position of the virtual compression link relative to the neutral plane. More specifically, the computer system can: map an anatomical model representing a reference anatomy to the virtual representation to identify circumferential regions of the joint; and interpret axial deformation of the virtual representation in the joint pose relative to the neutral plane to infer relative elongation or shortening of tissue at the circumferential regions.

For example, the computer system can: access a virtual representation representing a virtual finger in a partially flexed pose of a proximal interphalangeal joint; select a first longitudinal compliance for a first virtual compression link arranged proximal an upper surface of the virtual finger (i.e., experiencing greater axial elongation in the partially flexed pose); and elect a second longitudinal compliance, less than the first longitudinal compliance, for a second virtual compression link arranged proximal an underside surface of the virtual finger (i.e., experiencing shortening in the partially flexed pose). Thus, in this example, the computer system assigns greater longitudinal compliance to virtual compression links corresponding to regions of the finger that elongate during articulation and lower longitudinal compliance to virtual compression links corresponding to regions that shorten, such that the compression garment 100 can accommodate bending of the proximal interphalangeal joint while maintaining target compression.

Accordingly, the computer system can select longitudinal compliance based on joint pose and circumferential position to prevent localized over-constraint of the virtual compression garment 100 during articulation, which may inhibit joint motion or cause migration of the compression garment 100 along the finger.

### 18. Compression Garment With Multiple Longitudinal Compliance Zones

In one variation, Block S134 of the method S100 recites accessing a target mobility for the virtual representation. In this variation, the system can generate a compression garment 100 that includes multiple discrete zones configured to exhibit different longitudinal compliance while maintaining specified target radial compression. In this variation, the computer system can: section the virtual representation into regions corresponding to different functional requirements for joint mobility and compression; access or receive a target radial compression and/or target mobility for each region; downscale each region according to a corresponding target radial compression; and select target longitudinal compliance for each virtual compression link within each zone based on the target mobility.

In one example, the computer system can: access a virtual representation representing a lower leg; access a first target radial compression (e.g., medium compression) and first target mobility (e.g., high mobility) for a knee region of the virtual representation and a second target radial compression (e.g., high compression) and a second target mobility (e.g., immobilize) for an ankle region of the virtual representation; radially downscale the knee region of the virtual representation, radially about the center line, proportional to the first target radial compression; and radially downscale the ankle region of the virtual representation, radially about the center line, proportional to the second target radial compression. The computer system can then generate a three-dimensional model of the compression garment 100 including: a first set of virtual compression links cooperating to achieve the first target radial compression proximal the knee region and each exhibiting a longitudinal compliance, along the center line, proportional to the first target mobility; and a second set of virtual compression links cooperating to achieve the second target radial compression proximal the ankle region; and exhibiting a second longitudinal compliance, along the center line, proportional to the second target mobility.

Accordingly, by independently specifying target radial compression and target longitudinal compliance for each of the regions and generating corresponding sets of virtual compression links, the computer system can produce a three-dimensional model for a compression garment 100 that delivers region-specific compression and joint mobility characteristics, thereby enabling differentiated therapeutic support across the body part without imposing uniform stiffness or uniform mobility.

### 19. Compression Garment Applications

In one variation, the system can generate a garment that is not downsized for compression, such as a clothing item, a jewelry item, or a protective racing suit. In this variation, the computer system can implement methods and techniques described above to: access a virtual mesh representing a target body part (e.g., a wrist for a bracelet, a torso for a jacket, or a leg for a racing suit), for constructing a garment 100; downscale the virtual mesh according to the manufacturing offset between primary and secondary links of the garment; and generate a three-dimensional model of the garment 100. In particular, in this variation, the computer system does not downscale the virtual mesh according to a target compression for the garment 100 (i.e., the target compression is null) to generate a form-fitting but non-compressive garment 100. Thus, the system can construct garments 100 that conform to the target body part without applying compression to leverage the flexibility and structural properties of the network of links 110 for applications, such as fashion, protective gear, and accessories.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
accessing a virtual representation of a body part;
calculating a center line of the virtual representation;
radially downscaling the virtual representation, radially about the center line, according to a target radial compression for a compression garment;
projecting a primary rotation axis of a joint, represented in the virtual representation, onto the virtual representation;
calculating a neutral plane corresponding to minimal axial displacement of soft tissue proximal the joint, parallel to the center line, during articulation of the joint; and
generating a three-dimensional model of the compression garment by defining:
a first set of virtual compression links, each virtual compression link in the first set of virtual compression links,
cooperating to achieve the target radial compression proximal the joint; and
exhibiting a first longitudinal compliance, along the center line, based on proximity to the primary rotation axis and the neutral plane; and
a second set of virtual connector links, each virtual connector link in the second set of virtual connector links linking a pair of adjacent virtual compression links in the first set of virtual compression links.

2. The method of claim 1, wherein generating the three-dimensional model of the compression garment comprises generating the three-dimensional model of the compression garment by defining the first set of virtual compression links:
cooperating to achieve the target radial compression on the joint while the joint locates over a range of joint positions; and
comprising:
a first subset of virtual compression links:
arranged proximal a first region of the joint offset from the neutral plane and exhibiting axial displacement of tissue during articulation; and
configured to displace along the center line, relative to adjacent virtual compression links, to permit articulation of the joint over the range of joint positions; and
a second subset of virtual compression links:
arranged proximal a second region of the joint offset from the neutral plane and exhibiting minimal axial displacement of tissue during articulation; and
configured to resist axial displacement while the first subset of virtual compression links displace along the center line.

3. The method of claim 1, wherein generating the three-dimensional model of the compression garment comprises generating the three-dimensional model of the compression garment further comprising:
a third set of virtual compression links, each virtual compression link in the third set of virtual compression links:
cooperating to achieve the target radial compression proximal a region of the three-dimensional model excluding the joint; and
exhibiting a uniform longitudinal compliance.

4. The method of claim 1:
wherein calculating the neutral plane comprises:
snapping a three-dimensional surface onto the center line;
orienting the three-dimensional surface parallel to the primary rotation axis of the joint; and
defining the neutral plane along an outer surface of the virtual representation at an intersection between the three-dimensional surface and the outer surface; and
wherein generating the three-dimensional model of the compression garment comprises generating the three-dimensional model of the compression garment by defining the first set of virtual compression links.
each virtual compression link in the first set of virtual compression links exhibiting a first longitudinal compliance along the center line:
proportional to a first distance from the primary rotation axis; and
proportional to a second distance from the neutral plane.

5. The method of claim 1, wherein generating the three-dimensional model of the compression garment comprises generating the three-dimensional model of the compression garment by defining the first set of virtual compression links:
each virtual compression link in the first set of virtual compression links:
spaced apart from adjacent virtual compression links by a first separation distance proportional to a first longitudinal compliance of the virtual compression link; and
configured to translate along the center line, relative to adjacent virtual compression links, to permit articulation of the joint.

6. The method of claim 1, wherein generating the three-dimensional model of the compression garment comprises generating the three-dimensional model of the compression garment by defining the first set of virtual compression links:
each virtual compression link in the first set of virtual compression links:
exhibiting a thickness inversely proportional to a first longitudinal compliance of the virtual compression link; and
configured to elastically deform along the center line to permit articulation of the joint.

7. The method of claim 1:
wherein accessing the virtual representation comprises accessing the virtual representation depicting a joint pose of the joint; and
wherein generating the three-dimensional model of the compression garment comprises generating the three-dimensional model of the compression garment by defining the first set of virtual compression links:
each virtual compression link in the first set of virtual compression links exhibiting a first longitudinal compliance based on:
the joint pose; and
a circumferential position of the virtual compression link relative to the neutral plane.

8. The method of claim 1:
further comprising:
mapping an anatomical model, representing a reference anatomy, to the virtual representation; and
identifying the joint based on correspondence between anatomical features, represented in the virtual representation, and reference features represented in the anatomical model;
wherein projecting the primary rotation axis of the joint onto the virtual representation comprises:
mapping the primary rotation axis, defined in the anatomical model, to the virtual representation, the primary rotation axis defining a region of the virtual representation corresponding to axial displacement of tissue of the joint during articulation of the joint; and
wherein generating the three-dimensional model of the compression garment comprises generating the three-dimensional model of the compression garment by defining the first set of virtual compression links:
each virtual compression link in the first set of virtual compression links exhibiting a first longitudinal compliance, along the center line, based on proximity to the region defined by the primary rotation axis.

9. The method of claim 1:
wherein accessing the target radial compression comprises accessing a first target radial compression for a first region of the virtual representation;
further comprising accessing a first target mobility for the first region of the virtual representation; and
wherein generating the three-dimensional model of the compression garment comprises generating the three-dimensional model of the compression garment by defining the first set of virtual compression links:
each virtual compression link in the first set of virtual compression links:
cooperating to achieve the first target radial compression proximal the first region; and
exhibiting a first longitudinal compliance, along the center line, proportional to the first target mobility.

10. The method of claim 9:
wherein accessing the target radial compression comprises accessing a second target radial compression for a second region of the virtual representation;
further comprising accessing a second target mobility, less than the first target mobility, for the second region of the virtual representation; and
wherein generating the three-dimensional model of the compression garment comprises generating the three-dimensional model of the compression garment further comprising:
a third set of virtual compression links, each virtual compression link in the third set of virtual compression links:
cooperating to achieve the second target radial compression proximal the second region; and
exhibiting a second longitudinal compliance, along the center line, proportional to the second target mobility.

11. The method of claim 10, wherein the first region and the second region of the virtual representation can be selected from the group consisting of:
the first region comprising a knee region and the second region comprising an ankle region; and
the first region comprising a palm region and the second region comprising a knuckle region.

12. The method of claim 1, wherein calculating the center line of the virtual representation comprises:
defining an axis intersecting a first vertex and a second vertex arranged at a maximum separation distance in the virtual representation;
projecting a set of planes onto the virtual representation normal to the axis;
for each plane in the set of planes, projecting a center point, in a set of center points, of the plane into the virtual representation; and
generating the center line comprising a spline intersecting the set of center points projected into the virtual representation.

13. The method of claim 12:
wherein calculating the center line of the virtual representation further comprises:
for each plane, in the set of planes, intersecting the joint:
detecting a boundary of the virtual representation intersecting the plane;
calculating a centroid of the boundary; and
calculating a geometric reliability score for the plane based on differences between a centroid of the boundary and centroids of adjacent boundaries of adjacent planes; and
identifying a subset of planes, in the set of planes, characterized by geometric reliability scores falling below a threshold score; and
wherein projecting center points of the set of planes into the virtual representation comprises interpolating center points for planes, in the subset of planes, based on center points of planes, in the set of planes, characterized by geometric reliability scores exceeding the threshold score.

14. The method of claim 12:
wherein calculating the center line of the virtual representation further comprises:
for each plane, in the set of planes, intersecting a region of the virtual representation outside of the joint:
detecting a boundary of the virtual representation intersecting the plane; and
calculating a centroid of the boundary; and
wherein projecting center points of the set of planes into the virtual representation comprises, for each plane, in the set of planes, outside of the joint:
projecting a center point of the plane into the virtual representation at the centroid of the boundary.

15. The method of claim 1:
further comprising constructing a network of tessellated cells approximating a surface of the virtual representation; and
wherein generating the three-dimensional model of the compression garment comprises generating the three-dimensional model of the compression garment by defining:
the first set of virtual compression links: each virtual compression link in the first set of virtual compression links:
characterized by a primary equatorial plane intersecting and parallel to a surface of a tessellated cell in the network of tessellated cells; and
the second set of virtual connector links, each virtual connector link in the second set of virtual connector links:
intersecting surfaces of a pair of adjacent tessellated cells in the network of tessellated cells; and
characterized by a secondary equatorial plane perpendicular to surfaces of the pair of adjacent tessellated cells in the network of tessellated cells.

16. The method of claim 1, further comprising:
generating a print file representing the three-dimensional model of the compression garment; and
printing the compression garment according to the print file at an additive manufacturing system.

17. A method comprising:
accessing a virtual representation of a body part;
calculating a center line of the virtual representation;
radially downscaling the virtual representation, radially about the center line, according to a target radial compression for a compression garment;
identifying a joint represented in the virtual representation;
generating a three-dimensional model of the compression garment by defining:
a first set of virtual compression links, each virtual compression link in the first set of virtual compression links:
cooperating to achieve the target radial compression; and
exhibiting a longitudinal compliance based on proximity to the joint; and
a second set of virtual connector links, each virtual connector link in the second set of virtual connector links linking a pair of adjacent virtual compression links in the first set of virtual compression links; and
additively manufacturing the compression garment according to the three-dimensional model.

18. The method of claim 17:
further comprising projecting a primary rotation axis of the joint onto the virtual representation; and
wherein generating the three-dimensional model of the compression garment comprises generating the three-dimensional model of the compression garment by defining the first set of virtual compression links:
each virtual compression link in the first set of virtual compression links exhibiting a longitudinal compliance along the center line based on proximity to the primary rotation axis.

19. The method of claim 17:
further comprising calculating a neutral plane corresponding to minimal axial displacement of soft tissue proximal the joint, parallel to the center line, during articulation of the joint; and
wherein generating the three-dimensional model of the compression garment comprises generating the three-dimensional model of the compression garment by defining the first set of virtual compression links:
each virtual compression link in the first set of virtual compression links exhibiting a longitudinal compliance along the center line based on proximity to the neutral plane.

20. The method of claim 17, wherein generating the three-dimensional model of the compression garment comprises generating the three-dimensional model of the compression garment by defining:
the first set of virtual compression links, each virtual compression link in the first set of virtual compression links:
cooperating to achieve the target radial compression proximal the joint; and
configured to permit articulation of the joint; and
a third set of virtual compression links, each virtual compression link in the third set of virtual compression links:
cooperating to achieve the target radial compression proximal a region of the three-dimensional model excluding the joint; and
configured to resist axial displacement while the first set of virtual compression links permit articulation of the joint.
